(19) United States
(12) Patent Application Publication
(10) Pub. No.: US 2008/0069933 A1
(43) Pub. Date: Mar. 20, 2008

(54) LOW-CALORIE COHESIVE NON-FREE FLOWING SWEETENER COMPOSITIONS WITH DECREASED VOLUME

(76) Inventors: Renny Ison, Great Kingshill (GB); Melanie Loades, West Byfleet (GB); Gareth Williams, Reading (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/532,681

(22) Filed: Sep. 18, 2006

(51) Int. Cl. A23L 1/236

(52) U.S. Cl. 426/548

(57) ABSTRACT

Cohesive non-free flowing sweetener compositions for adding sweetness to liquid foodstuffs, for example, beverages, having a reduced volume and caloric burden as compared to conventional sucrose cubes of the same size, are provided. More particularly, a cohesive non-free flowing sweetener composition containing a high intensity sweetener and a bulking agent, wherein the cohesive non-free flowing sweetener composition has a shape with a volume lower than that of a conventional sucrose cube of the same dimensions an equivalent sweetness equivalent is provided. Methods of making such cohesive non-free flowing sweetener compositions are also provided.

### FIELD OF THE INVENTION

The present invention relates to cohesive non-free flowing sweetener compositions with decreased volume compared to conventional sucrose cubes of similar size for delivering sweetness to a liquid foodstuff, for example, a beverage. More particularly, the present invention relates to cohesive non-free flowing sweetener composition containing a high intensity sweetener and a bulking agent, wherein the cohesive non-free flowing sweetener compositions has a volume less than that of a conventional sucrose cube of about the same dimensions and an equivalent sweetness. The present invention also relates to methods of making sweetener cube-shaped cohesive non-free flowing sweetener compositions.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for sweetener products that consumers may use to increase the sweetness of a product at the time of consumption that are consistent with their personal preferences and minimize additional caloric burden.

Methods for sweetening liquid foodstuffs are known. For example, adding sweetener to an unsweetened iced tea beverage will typically involve adding the sweetener to the unsweetened iced tea beverage followed by stirring to disperse the sweetener to create a sweetened iced tea beverage. Such a sweetener is typically in a cube, tablet, granular, powdered, or liquid form.

Sweetening individual servings of a beverage presents a challenge in many food service situations. Frequently, an individual packet of a sweetener is provided along with a serving of a beverage. The packet may contain sucrose, or alternatively may contain high intensity sweeteners such as sucralose, aspartame, or saccharin and a standard bulking agent such as sucrose, glucose or maltodextrin; all of which have a typical calorific value of 4 kilocalories per gram. The user must open the packet and empty the contents into the beverage, and then stir the beverage to obtain dissolution of the sweetener and its complete dispersion in the liquid. The residual packaging of the packet creates waste that may present disposal problems under many situations. Alternatively, sweetener may be provided in the form of single serve cohesive non-free flowing sweetener composition, which contains approximately one (or more) sucrose equivalent teaspoon(s) of sweetness (one sucrose equivalent teaspoon being about 4 to about 5 grams per teaspoon of sucrose). Typically, such sweetener cubes do not require individual packaging, and therefore, reduce the steps involved in sweetening the beverage and the waste associated with the sweetener.

Sweetener cubes are cohesive non-free flowing compositions that include bulking agents. Bulking agents are typically crystalline carbohydrates, such as, sucrose, which are also available in combination with high intensity sweeteners. More recently a number of lower caloric burden bulking agents have entered the market. Some of these lower caloric burden bulking agents have physical and sensory characteristics similar to sucrose, and others have only a few physical or sensory characteristics similar to sucrose and/or some undesirable characteristics.

The availability of high intensity sweeteners provide the ability to lower the caloric burden involved with sweetening a liquid foodstuff, e.g., individual servings of beverages. For example, sucralose is about 500 to about 600 times as sweet as sucrose (a.k.a. table sugar and cane sugar). One teaspoon of sucrose, which is about 4 to about 5 grams of sucrose, may be replaced by about 6.7 to about 10 milligrams of sucralose. The minute quantities of high intensity sweeteners needed to achieve preferred sweetening of individual servings offer the opportunity to provide new technologies to deliver sweetness to foodstuffs, including individual servings.

In view of the foregoing, it would be advantageous to provide a cohesive non-free flowing sweetener composition with a lower caloric burden that has physical and sensory characteristics similar to those of a sucrose cube that may be manufactured commercially and is convenient for the consumer.

### SUMMARY OF THE INVENTION

One embodiment of the present invention is a cohesive non-free flowing sweetener composition comprising, consisting of, and/or consisting essentially of a high intensity sweetener and a bulking agent, wherein the cohesive non-free flowing sweetener composition has a decreased volume and an equivalent sweetness compared to that of a conventional sucrose cube of the same dimensions.

Another embodiment of the present invention is a cohesive non-free flowing sweetener composition comprising, consisting of, and/or consisting essentially of about 0.4% sucralose and about 99.6% erythritol by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and a) wherein at least one cylinder of a diameter from about 1.5 to about 5 millimeters is bored through and perpendicular to two parallel surfaces of the cohesive non-free flowing sweetener composition or b) wherein one or two of the surfaces have been modified with at least one dent.

A further embodiment of the present invention is a cohesive non-free flowing sweetener composition comprising, consisting of, and/or consisting essentially of about 0.4% sucralose, about 75% erythritol, about 20% crystalline lactose, and about 4.6% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 9 millimeters by about 9 millimeters by about 9 millimeters and six surfaces and a) wherein at least one cylinder of a diameter from about 1.5 to about 5 millimeters is bored through and perpendicular to two parallel surfaces of the cohesive non-free flowing sweetener composition or b) wherein one or two of the surfaces have been modified with at least one dent.

An additional embodiment of the present invention is a cohesive non-free flowing sweetener composition comprising, consisting of, and/or consisting essentially of about 0.4% sucralose, about 10% polydextrose, about 57% erythritol, and from about 26% to about 33% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and a) wherein at least one cylinder of a diameter from about 1.5 to about 5 millimeters is bored through and perpendicular to two parallel surfaces of the cohesive non-free flowing sweetener composition or b) wherein one or two of the surfaces have been modified with at least one dent.

A further embodiment of the present invention is a cohesive non-free flowing sweetener composition comprising, consisting of, and/or consisting essentially of about 0.4% sucralose, about 10% polydextrose, about 38% erythritol, and from about 45% to about 52% trehalose by weight based on the total weight of the sweetener cube, wherein the sweetener cube has a sweetness equal to one teaspoon of sucrose and is in the shape of a rectangular prism having dimensions of about 12 millimeters by about 12 millimeters by about 9 millimeters and six surfaces and a) wherein at least one cylinder of a diameter from about 1.5 to about 5 millimeters is bored through and perpendicular to two parallel surfaces of the cohesive non-free flowing sweetener composition or b) wherein one or two of the surfaces have been modified with at least one dent.

A further embodiment of the present invention is a cohesive non-free flowing sweetener composition comprising, consisting of, and/or consisting essentially of about 0.4% sucralose, about 10% polydextrose, about 30% erythritol, and about 60% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and a) wherein at least one cylinder of a diameter from about 1.5 to about 5 millimeters is bored through and perpendicular to two parallel surfaces of the sweetener cube of the cohesive non-free flowing sweetener composition or b) wherein one or two of the surfaces have been modified with at least one dent.

A further embodiment of the present invention is a method for making a low-calorie cohesive non-free flowing sweetener composition comprising, consisting of, and/or consisting essentially of the steps of combining a high intensity sweetener with a bulking agent to form a blend, adding water to the blend, forming the blend into a shape, and drying the shape, wherein either the shape has a volume lower than that of a conventional sucrose cube of about the same dimensions or the sweetener cube is modified with a surface feature.

### BRIEF DESCRIPTION OF THE DRAWINGS

FIGS. 1A-C show the shapes of cohesive non-free flowing sweetener compositions: A) Cube; B) Rectangular Prism; and C) Wafer. FIGS. 1D-J show various examples of cohesive non-free flowing sweetener composition shapes of the present invention: D) Cylinder; E) Cylinder; F) Disc; G) Heart; H) Star; I) Moon; J) Waist in Two Dimensions.

FIGS. 2A-E show various examples of cohesive non-free flowing sweetener compositions modified with a surface feature: A) Dimples; B) Trench; C) Hole; D) Etching—company logo; and E) Etching—crosshatching and cross-sections of 2A-C and 2E.

### DETAILED DESCRIPTION OF THE INVENTION

To reduce the caloric burden of a sucrose cube, the amount of sucrose is decreased, which results a smaller cube size. The sweetness lost due to the decreased amount of sucrose in the cube can be offset by incorporating high intensity sweeteners, such as, aspartame or acesulfame K into the cube formulation. While such a formulation does reduce the cube's caloric burden, this reduction is limited by the minimum size of the cube that can be manufactured and handled by the consumer. A review of products currently on the market revealed a minimum cube size of about 1.4 grams, which results in a sucrose-containing sweetener cube having about 5.6 kilocalories.

Cohesive non-free flowing sweetener compositions of the present invention may be of any size convenient for manufacture and acceptable for use by a consumer. Preferably the cohesive non-free flowing sweetener compositions are less than about 20 millimeters in height, less than about 20 millimeters in width, and less than about 20 millimeters in depth. More preferably, the cohesive non-free flowing sweetener compositions has two sides that are about 12 millimeters by about 12 millimeters and four sides that are about 9 millimeters by about 12 millimeters.

The cohesive non-free flowing compositions of the present invention can be shaped to produce sweetener cubes having a volume about 2% to about 50% less than a conventional sucrose cube of about the same dimensions or size. Preferably, the cohesive non-free flowing sweetener compositions of the present invention have a volume about 10% to about 25% less, more preferably about 15% less than a conventional sucrose cube of about the same dimensions.

As used herein, all numerical ranges provided are intended to expressly include at least all numbers that fall between the endpoints of recited ranges.

As used herein, the term “conventional sucrose cube” means a rectangular prism of crystalline sucrose having a height, width, and depth from about 5 millimeters to about 20 millimeters. Typically, a conventional sucrose cube is about 15 millimeters on each side and has a caloric burden of about 25 kilocalories. As noted above, the smallest commercially available and consumer accepted high intensity sweetener/sucrose cubes have two sides that are about 12 millimeters by about 12 millimeters and four sides that are about 9 millimeters by about 12 millimeters and have a caloric burden of about 5.6 kilocalories and weight of about 1.4 grams.

### High Intensity Sweetener

As used herein, the term “high intensity sweetener” means a substance that provides a high sweetness per unit mass as compared to sucrose and provides little or no nutritive value.

Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof. A preferred high intensity sweetener according to the present invention is sucralose.

Cohesive non-free flowing sweetener compositions of the present invention may contain from about 0.01% (wt) to about 3.5% (wt) of a high intensity sweetener. More preferably, cohesive non-free flowing sweetener compositions of the present invention may contain from about 0.05% (wt) to about 2% (wt), even more preferably from about 0.1% (wt) to about 1% (wt) of a high intensity sweetener based on the weight of the cohesive non-free flowing sweetener composition

If the only high intensity sweetener used is sucralose, the cohesive non-free flowing sweetener compositions of the present invention preferably contain from about 0.1% (wt) to about 0.6% (wt) of sucralose. More preferably, such a cohesive non-free flowing sweetener composition of the present invention contains from about 0.2% (wt) to about 0.5% (wt), even more preferably from about 0.4% (wt) to about 0.5% (wt) of sucralose based on the weight of the cohesive non-free flowing sweetener composition.

### Bulking Agents

The specific bulking agent(s) are selected to produce sweetener cubes from the cohesive non-free flowing sweetener composition with physical and sensory characteristics similar to those of a sucrose cube. Such sweetener cubes may contain specific bulking agents that have physical and sensory properties similar to sucrose or may contain a combination of bulking agents that individually do not, but when combined do, have characteristics similar to sucrose. Numerous factors must be considered in the selection of bulking agents for use in the present invention.

First, the bulking agent generally has a sweetness intensity well below that of sucrose, so the addition of a high intensity sweetener is required to produce a sweetener cube from the cohesive non-free flowing sweetener composition that has a level of sweetness acceptable to consumers. The amount of high intensity sweetener used in such a sweetener cube is inversely related to the native sweetness of the bulking agent. Care must be taken to properly balance the ingredients to produce the sweetness expected by the consumer that is approximately equal to the sweetness of a sucrose-containing sweetener cube, e.g., one teaspoon of sucrose.

As used herein, the term “teaspoon” refers to a standard teaspoon, which has a volume of about 5 milliliters. Accordingly, a teaspoon of sucrose has a mass of about 4 to about 5 grams.

Second, bulking agent(s) must be selected that are acceptable to consumers in roughly five areas: appearance, taste, side effects, use, and cost. With regard to appearance, the sweetener cubes from the cohesive non-free flowing sweetener composition should mirror its sucrose equivalent as much as possible. The cohesive non-free flowing sweetener composition should appear crystalline. And, the cohesive non-free flowing sweetener composition should maintain its shape during storage and transport. For example, proteins will often have non-crystalline appearance and some sugars have yellow or sallow color. Neither will produce an acceptable sweetening cube when used in isolation as a bulking agent. Moreover, some possible bulking agents are far too hygroscopic to maintain cube integrity and shape for any length of time when used in isolation. For example, soluble fibers may absorb so much water from the environment that the cohesive non-free flowing sweetener compositions will begin to dissolve into a syrup that is undesirable to, and often unusable by consumers.

As used herein, the term “bulking agent” means a food grade substance that may be used to produce a cohesive non-free flowing sweetener composition with sensory and physical characteristics similar to that of a conventional sucrose cube. Examples of bulking agents for use in the present invention include mono- and disaccharides, such as, glucose, allose, altrose, mannose, idose, galactose, talose, ribose, arabinose, xylose, lyxose, cellobiose, gentiobiose, isomaltose, lactose, laminarabinose, maltose, amylose, mannobiose, xylobiose, sucrose, trehalose, cellobiose, lactulose, fructose, tagatose, lactitol; aerated sugars, aerated polyols, and aerated complex carbohydrates; oligosaccharides and polysaccharides, such as, cyclodextrins, raffinose, cellulose, inulin, gum arabic, nutriose, maltodextrin, fibrisol, raftiline, raftilose; polyols, such as, isomalt, lactitol, maltitol, xylitol, erythritol, mannitol, sorbitol; soluble fiber; protein; calcium citrate; calcium lactate, and combinations thereof. Preferred bulking agents according to the present invention are polydextrose, erythritol, tagatose, trehalose, lactose and combinations thereof.

As used herein, a “food-grade” material is one that conforms to the standards for foods deemed safe for human consumption set forth in the Codex Alimentarius produced by the World Health Organization (1999).

The bulking agent(s) used in the present invention are selected to produce cohesive non-free flowing sweetener compositions that will be readily accepted by consumers as an alternative to sucrose cubes. To maximize consumer appeal and similarity to sucrose bulking agents may be combined as part of this invention when the individual bulking agents do not deliver sufficient of the correct characteristics or deliver negative characteristics. The correct combination of these bulking agents minimizes or eliminates the undesirable characteristics.

Preferably, the cohesive non-free flowing sweetener compositions of the present invention contain from about 1% (wt) to about 99.5% (wt) of a bulking agent. More preferably, the cohesive non-free flowing sweetener compositions of the present invention contain from about 10% (wt) to about 75% (wt), even more preferably about 30% (wt) to about 60% (wt) of a bulking agent.

The bulking agents may be processed using methods known in the art to achieve a lower density. For example, agglomerated maltodextrin may be produced by fluid bed drying standard maltodextrin and aerated products may be produced by foam spray drying with the incorporation of a dissolved gas (e.g. carbon dioxide) in the feed to the spray dryer. Moreover, lower density forms of the bulking agents may be produced by extrusion and cavitation technologies.

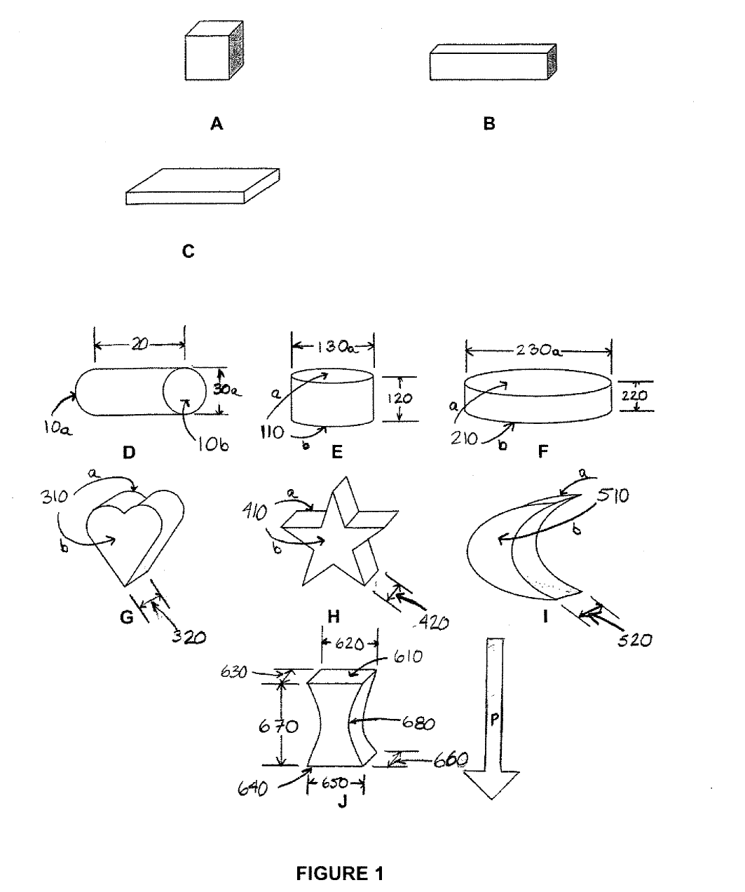

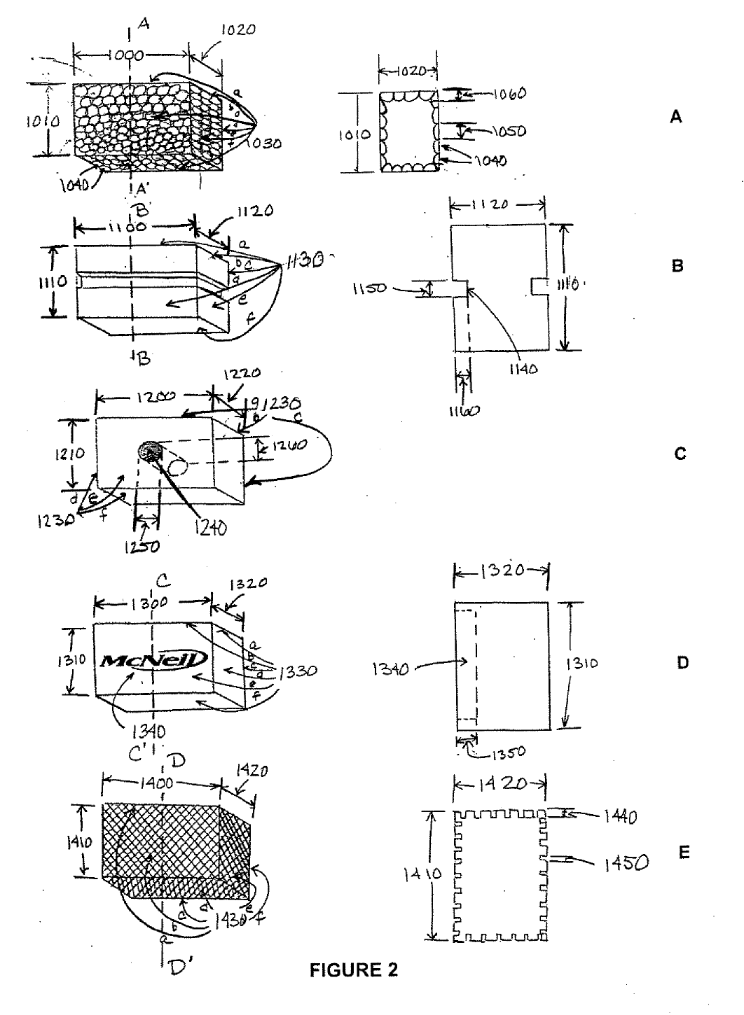

As used herein, the term “sweetening cube” means a three-dimensional structure made up of cohesive particles and containing a high intensity sweetener. Thus, in the present invention the term sweetening cube embraces any three dimensional structure that may be manufactured from the materials described herein. Such structures include those depicted in FIGS. 1 and 2.

### Volume Reduction

In the present invention, the volume, and therefore, the caloric burden of the sweetening cube made from the cohesive non-free flowing sweetener composition of the present invention may be decreased, compared to a conventional sucrose cube, in two ways. First, the overall shape of the cube may be modified to decrease the volume. Second, the surface of the cube may be modified to reduce the volume of the cube, while the overall shape of the cube is maintained. Combinations of these two methods may also be employed.

In an embodiment of the present invention, the overall shape is modified to produce a sweetener cube made from the cohesive non-free flowing sweetener composition with a decreased volume compared to a conventional sucrose cube of about the same dimensions. For example, the corners of the rectangular prism of a conventional sucrose cube may be rounded or shaved to produce a more spherical shape. Examples of shapes useful in the present invention include, e.g., pyramids (not shown), cylinders (FIG. 1D or E), cones (not shown), spheres (not shown), discs (FIG. 1F), waists in two dimensions (FIG. 1J), fun shapes, and the like.

As with the cohesive non-free flowing sweetener composition shape, surface feature(s) may act as a unique feature for marketing the cohesive non-free flowing sweetener compositions. For example, cohesive non-free flowing sweetener compositions with the letters of the alphabet etched on their surfaces may be packaged together. Moreover, the surface features on the cohesive non-free flowing sweetener composition may have a source identifier (e.g., a company logo etched on the surface) and imbue the cohesive non-free flowing sweetener compositions with trademark/trade dress value. Preferably, the surface feature is a dent.

In one embodiment of the present invention, the sweetener cube made from the cohesive non-free flowing sweetener composition is in the form of a cylinder (FIG. 1D or 1E) or a disc (FIG. 1F). Cylinders have two circular ends (identified as 10a and 10b or 110a and b in FIGS. 1D and 1E) each with a diameter (identified as 30a and 30b (not shown) or 130a and b(not shown) in FIGS. 1D and 1E) and separated by a length (20 or 120). A disc (FIG. 1F) is a cylinder having two circular ends (210a and 210b) each with a diameter (230a and 230b (not shown)) and separated by a length (220) of less than about one quarter of the diameter. Conical sweetener cubes (not shown), which have circular ends of different diameters or have a point at one end, are also useful in the present invention.

As used herein, the term “fun shapes” means any shape that the consumer would readily identify and find surprising or memorable for a cohesive non-free flowing sweetener composition. Examples of fun shapes useful in the present invention include, e.g., the suits of a deck of cards (diamonds (not shown), hearts (FIG. 1G), clubs (not shown) and spades (not shown), letters (not shown), numbers (not shown), stars (FIG. 1H), moons (FIG. 1I), flowers (not shown), insects (not shown), animals (not shown), and the like. These fun shapes have a two parallel surfaces (310a and 310b (heart), 410a and 410b (star), or 510a and 510b (moon)) in the readily identifiable and surprising or memorable shape separated by a depth (320, 420, or 520, respectively). These fun shapes may act as a unique feature for marketing the cohesive non-free flowing sweetener compositions. For example, fun shapes formed from cohesive non-free flowing sweetener compositions may be packaged to contain the letters of the alphabet or various animals, akin to animal crackers. Moreover, the shape of the cohesive non-free flowing sweetener compositions may serve as a source identifier (e.g., a company logo) and imbue the cohesive non-free flowing sweetener composition with trademark and/or tradedress properties.

As used herein, the term “waist in two dimensions” (FIG. 1J) means a cube-like shape with two parallel, planar sides and four sides with a concave shape. A waist in two dimensions has a first rectangular end (610) and a second rectangular end (640) each with a length (620 and 650, respectively) and a width (630 and 660, respectively) separated by a height (670). Both, the length and width of the waist in two dimensions decrease as one travels along the height from the first rectangular end (610) to the midpoint (680) of the height (670) and the length and width of the waist in two dimensions then increases as one travels from the midpoint of the height to the second rectangular end (640) (path P designated by arrow). Preferably, the sweetener cube is in the shape of a waist in two dimensions.

In another embodiment of the present invention, the surface of the cohesive non-free flowing sweetener composition has been modified with a surface feature to provide a cube with a lower volume compared to a conventional sucrose cube of about the same dimensions without modifying the overall shape of the cube.

As used herein, the term “surface feature” means any modification to the cohesive non-free flowing sweetener composition that does not result in a change in the overall shape of the cube. Examples of surface features useful in the present invention include, e.g., dents, divots, dimples (FIG. 2A), trenches (FIG. 2B), ridges, and grooves, holes fully or partially through the sweetener cube (FIG. 2C), and etchings (FIGS. 2D and 2E).

For example, the surface feature may be dimpled (FIG. 2A) to produce a surface on the cohesive non-free flowing sweetener composition like that of a golf ball. The cohesive non-free flowing sweetener composition has a length (1000), a width (1010), and a depth (1020). On each of the six surfaces (1030a-f) of the cohesive non-free flowing sweetener composition are a multitude of dimples (1040) having a circular or oblong shape. A cross-section perpendicular to and bisecting the length (1000) of the cohesive non-free flowing sweetener composition along line A-A′ shows dimples with a diameter (1050) from about 0.5 millimeter to about 2 millimeters and depth (1060) from about 0.5 millimeters to about 2 millimeters. In the present invention, the depth and diameter of the dimples need not be the same for each dimple and may vary from surface to surface or vary on a single surface. Moreover, the dimples may be spaced apart or adjacent to each other.

FIG. 2B shows an embodiment of the present invention with a trench as the surface feature. In this embodiment, the cohesive non-free flowing sweetener composition has a length (1100), a width (1110), and a depth (1120) and six surfaces (1130a-f). A cross-section perpendicular to and bisecting the length (1000) of the cohesive non-free flowing sweetener composition along line B-B′ shows a trench (1140) having a width (1150) and depth (1160) that runs parallel to the length (1100) and depth (1120) of the cohesive non-free flowing sweetener composition and circumscribes the cohesive non-free flowing sweetener composition. In the present invention, the width and depth of the trench need not be constant, but may vary from surface to surface or vary on a single surface. There may be more than one trench on a cohesive non-free flowing sweetener composition. A trench may run perpendicular to or parallel to a dimension of the cohesive non-free flowing sweetener composition or may run at any angle between the two. The dimensions of the trench may be from about 1 millimeters to about 8 millimeters in width (1150), preferably from about 1 millimeters to about 4 millimeters, more preferably from about 2 millimeters to about 3 millimeters and about 1 millimeters to about 4 millimeters in depth (1160), preferably from about 1 millimeters to about 3 millimeters, more preferably about 2 millimeters.

FIG. 2C shows an embodiment of the present invention with a cylinder through the cube as the surface feature. The cohesive non-free flowing sweetener composition has a length (1200), a width (1210), and a depth (1220) and six surfaces (1230a-f). A cylinder (1240) having a diameter (1250) and depth (1260) has been bored perpendicular to the two parallel surfaces (1230) of the cohesive non-free flowing sweetener composition separated by the depth (1220) and completely through the depth of the cube. It should be noted that in the present invention, the depth of the cylinder may be less than the dimension of the cohesive non-free flowing sweetener composition into which it is bored. In such an instance, the cylinder would pass only partially through the cohesive non-free flowing sweetener composition. Moreover, the cohesive non-free flowing sweetener composition may have more than one cylinder and the cylinder(s) may be bored perpendicular or parallel to any dimension of the cohesive non-free flowing sweetener composition or at any angle in between. The number, diameter, and depth of the cylinder bored in the cohesive non-free flowing sweetener composition are only limited in that they may not compromise the integrity of the cohesive non-free flowing sweetener composition. The dimensions of the cylinder may be from about 1.5 millimeters to about 5 millimeters in diameter (1250), preferably from about 2 millimeters to about 4 millimeters, more preferably about 3 millimeters and about 1 millimeters to about 6 millimeters in depth (1260), preferably from about 1 millimeters to about 4 millimeters, more preferably about 2 millimeters. Moreover, the hollowed out shape may take any form, e.g., a rectangular prism, triangular prism, etc., not just the cylinder depicted.

FIG. 2D shows an embodiment of the present invention with an etching of a company logo as the surface feature. The cohesive non-free flowing sweetener composition has a length (1300), a width (1310), and a depth (1320) and six surfaces (1330a-f). A cross-section perpendicular to and bisecting the length (1300) of the cohesive non-free flowing sweetener composition along line C-C′ shows a company logo (1340) having a depth (1350) etched into one of the surfaces (1330e) of the cohesive non-free flowing sweetener composition formed by the length (1300) and width (1310). It should be noted that in the present invention, the company logo may be etched on any surface of the cohesive non-free flowing sweetener composition or on multiples surfaces. Moreover, the company logo may be etched to any depth, e.g., from about 0.5 millimeter to about 3 millimeters, preferably about 2 millimeters, that does not compromise the integrity of the cohesive non-free flowing sweetener composition.

FIG. 2E shows an embodiment of the present invention with an etched crosshatch pattern as the surface feature. The cohesive non-free flowing sweetener composition has a length (1400), a width (1410), and a depth (1420) and six surfaces (1430a-f). A cross-section perpendicular to and bisecting the length (1400) of the cohesive non-free flowing sweetener composition along line D-D′ shows the etched cross-hatching having a depth (1440) and a width of (1450) on the surfaces (1430a-f) of the cohesive non-free flowing sweetener composition. In the present invention, the etching on the surface of the cohesive non-free flowing sweetener composition need not be crosshatching or even linear (see the company logo, above). The etching may be on any surface or on multiple surfaces of the cohesive non-free flowing sweetener composition, and may be of any depth and pattern that does not compromise the integrity of the cohesive non-free flowing sweetener composition. For example, the cross-hatching may have a depth (1440) of from about 0.5 millimeters to about 3 millimeters and a width (1450) from about 0.1 millimeters to about 0.5 millimeters. The cross-hatching may be evenly spaced or randomly spaced.

### Producing Cohesive Non-Free Flowing Sweetener Compositions

Cohesive non-free flowing sweetener compositions are generally produced by a process having the following steps: (a) blending the ingredients, (b) forming a shaped composition, and (c) drying the composition. Obviously, each step may have a number of variations.

A further embodiment of the present invention is a method for making a cohesive non-free flowing sweetener composition including the steps of combining a high intensity sweetener, a bulking agent to form a blend, adding water to the blend, forming the blend into a shape, and drying the shape, wherein either the shape has a volume lower than that of a conventional sucrose cube of about the same dimensions or the cohesive non-free flowing sweetener composition is modified with a surface feature. Preferably, the surface feature is a dent.

While the manner in which the ingredients are blended is not critical, overly aggressive blending may result in an undesirable particle size reduction. It is, however, imperative to have a uniform distribution of the ingredients throughout the blend. Otherwise, both the sweetness and the caloric burden will vary from shape to shape. For ingredients used in small amounts it may be necessary to produce a pre-blend to ensure even distribution. If an ingredient tends to cake or lump, it may need to be passed through a sieve. The most common blenders are those that allow for continuous addition of ingredients.

Forming a shaped cohesive non-free flowing sweetener composition generally has two phases. First, the blended ingredients are hydrated to a moisture content from about 0.3% to about 3%, usually by the introduction of water or steam. Second, the hydrated ingredients are placed into dyes or molds and compressed to form the desired shape. The hydrated mixture may also be formed into large blocks and later broken into “rough cut” shapes.

Once the hydrated mixture has been formed into the desired shape it is dried. Drying may be accomplished using ovens or, if conditions permit, by exposure to ambient air. The most common dryers are continuous bands passing through a drying tunnel. Drying temperatures and times vary considerably. For example, in ambient air the drying time may be about 24 hours. In contrast, drying in an oven at about 60° C. to about 75° C. can take as little as about 10 to about 20 minutes. A conditioning step may also be required after oven or air-drying of approximately about 12 to about 36 hours to allow moisture to equilibrate throughout the products.

The shape of the mold chosen to form the cohesive non-free flowing sweetener composition determines the overall shape of the cohesive non-free flowing sweetener composition. Any desired shape can be used, including, cube, ball, pyramid, and the like. Additionally, the surface of the cohesive non-free flowing sweetener composition may modified to introduce a feature. A surface feature may be imparted by the surface of the mold used to form the cohesive non-free flowing sweetener composition or the dried cohesive non-free flowing sweetener composition may be further processed to produce the desired surface feature. In addition, the cohesive non-free flowing sweetener composition may also be shaped when still damp to introduce surface features or to produce novel shapes. For example, the dried cohesive non-free flowing sweetener composition may be laser or mechanically etched, or the desired feature may be burned into the surface of the cohesive non-free flowing sweetener composition using a heated tool. Once dry, the cohesive non-free flowing sweetener composition is then packed into tubs, boxes or other food appropriate packaging prior to consumer use.

The shapes and surface features of the cohesive non-free flowing sweetener compositions of the present invention may be introduced in two ways. First, the dyes or molds used to form a shaped cohesive non-free flowing sweetener composition may be contoured to produce the novel shapes or surface features during the shape formation. Second, after drying, the shaped cohesive non-free flowing sweetener composition may be cut or milled to produce the desired shape or surface feature.

Cohesive non-free flowing sweetener compositions of the present invention may be of any size convenient for manufacture and acceptable for use by a consumer. Cubes formed of the cohesive non-free flowing sweetener compositions are generally less than about 20 millimeters in height, less than about 20 millimeters in width, and less than about 20 millimeters in depth. Other useful sizes include about 12 millimeters in height, about 12 millimeters in width, and about 9 millimeters in depth, and even more preferably about 9 millimeters in height, about 9 millimeters in width, and about 9 millimeters in depth.

Another embodiment of the present invention is a low-calorie sweetener cube made according to one of the processes described herein.

### Consumer Preferences

A conventional sucrose cube is the standard to which all other sweetening cube products are compared. Any sweetening cube product that deviates significantly from the physical and sensory characteristics of a conventional sucrose cube is not likely to be acceptable to the consumer. Table 1 shows physical and sensory characteristics of sucrose cubes and acceptable ranges for other sweetening cube products.

TABLE 1
Physical and sensory characteristics of sucrose cubes and
acceptable ranges for other sweetening cube products.

| Characteristic | Sucrose cube | Acceptable range |
|---|---|---|
| Appearance | White, crystalline | Color from white to pale cream, crystalline |
| Taste | Sweet, syrupy | Delivery of sweetness, no other strong |
| | | flavor notes (i.e. any additional flavors |
| | | must not be stronger than the sweetness) |
| Undesirable | None | Minimal negative consumer related claims |
| effects | | such as laxative effect |
| Stability | Maintains shape during | Maintains cube shape during processing |
| | storage and transport | and transport up to 75% RH |
| Solubility | Approx. 30 seconds in hot | Cube dissolves in hot water (150 ml at |
| | water (85° C.) | 85° C.) in about 10 to about 60 seconds with |
| | | agitation |
| Friability | Maintains integrity on | Less than 10% weight loss from dry cube |
| | handling | when agitated for 60 seconds |
| Hardness | 4000 g pressure (bench | 1,000–15,000 g for laboratory made |
| | made), 25,000 machine | samples, up to 30,000 g for pilot scale / |
| | made (texture analyzer) | commercially made samples |
| Particulate size | 0–2 millimeters | 0–3 millimeters for overall blend of |
| range | | ingredients used to make up the cube |

To be accepted by a consumer as an acceptable substitute for a conventional sucrose cube, a cohesive non-free flowing sweetener composition of the present invention must have enough sensory and physical characteristics within the acceptable ranges shown in Table 1. Every characteristic of the sweetener cube formed from the cohesive non-free flowing sweetener composition need not fall within the ranges in Table 1 for the sweetener cube to be acceptable to a consumer. For example, a sweetener cube of the present invention intended to replace a brown sugar cube would have a brown color, and therefore, would not fall with the acceptable range for “appearance” in Table 1, but would still be acceptable to a consumer.

With regard to taste, a sweetener cube formed from a cohesive non-free flowing sweetener composition of the present invention should give a sweetness level equivalent to a similar weight of sucrose cube, and deliver a sweetness profile similar to sucrose. With regard to side effects, the bulking agent must not produce undesirable or unexpected side effects for the consumer. For example, some sugar alcohols may have a laxative effect on the consumer. Unless this is a desired effect, a cohesive non-free flowing sweetener composition employing such sugar alcohols would not find consumer acceptance.

The cohesive non-free flowing sweetener compositions must also function as expected by the consumer and quickly dissolve to produce the desired sweetness in the foodstuff. For example, the bulking agent may have a low solubility in water, and therefore, the cohesive non-free flowing sweetener composition may dissolve too slowly for the consumer or may not dissolve completely. As noted above, the production of cohesive non-free flowing sweetener compositions with desirable consumer characteristics may be achieved either by the use of a single bulking agent with the desired characteristics or by the use of a combination bulking agents that together produce the desired characteristics.

With regard to cost, the cohesive non-free flowing sweetener compositions should be of acceptable cost to the consumer when compared with other sweetening formats, such as tablets, sucrose cubes, sucrose, high intensity sweeteners, and granular sweeteners. For example, erythritol may be sourced commercially in a white crystalline format of good particulate size similar to sucrose, but may be comparatively expensive; therefore this may be combined with a less expensive bulking agent such as maltose and still provide the required overall characteristics.

Overlapping with the above considerations are various bulking agent characteristics that affect the production and/or storage and transport of cohesive non-free flowing sweetener compositions. These characteristics include: caloric burden, friability, dissolution, heat of solution, hardness, rigidity, moisture uptake, effect of humidity, and effect of temperature. Processing considerations include ease of raw material storage and processing and ease of flow of mixture for consistent and accurate fill of molds. Table 2 lists various ingredients and factors that must be considered in screening for the proper bulking agent(s) useful in a cohesive non-free flowing sweetener compositions of the present invention.

TABLE 2
Potential bulking agents.

| Ingredient | | | | Screening Factors | |
|---|---|---|---|---|---|
| Class | Subclass | Examples | kcal/g | Negatives | Positives |
| Protein | | | 4.0 | Non-crystal appearance | |
| Carbohydrates | Sugars | Sucrose | 4.0 | Consumer negative | |
| | | Fructose | 4.0 | Hygroscopic | |
| | | Lactose | 4.0 | Mostly Small particulates | Low cost |
| | | Galactose | 4.0 | High cost | |
| | | Maltose | 4.0 | | Low cost, Crystalline |
| | | Trehalose | 4.0 | | Excellent appearance |
| | | Tagatose | 1.5 | | Crystalline, Low calorie |
| | Sugar alcohols | Mannitol | 1.6 | Laxative effect | |
| | | Sorbitol | 2.6 | Laxative effect | |
| | | Xylitol | 2.4 | Laxative effect | |
| | | Erythritol | 0.2 | Negative heat of solution | |
| | Complex | Maltodextrin | 4.0 | Non crystalline | Low cost bulking |
| | Carbohydrates | | | | Glue effect |
| | | Polydextrose | 1.0 | Non crystalline | Glue effect |
| | | Soluble Fiber | 1.0–2.0 | Hygroscopic, Laxative | |
| Minerals | | Ca citrate | 2.0 | | Powdery, Possible bulk |
| | | Ca lactate | 2.0 | | Powdery, Possible bulk |

Even if an ingredient is appropriate for use as a bulking agent, the proportion of the ingredient used in the cohesive non-free flowing sweetener composition may have significant effects on the characteristics of the composition. The following examples are provided to further illustrate the compositions and methods of the present invention. These examples are illustrative only and are not intended to limit the scope of the invention in any way.

Another embodiment of the present invention is a low-calorie sweetener cube made according to one of the processes described herein.

The following examples are provided to further illustrate the compositions and methods of the present invention. These examples are illustrative only and are not intended to limit the scope of the invention in any way.

### EXAMPLES

### Example 1

The cohesive non-free flowing sweetener compositions of the present invention may be made in any manner known in the art. Described below are two methods for producing cohesive non-free flowing sweetener compositions of the present invention: A) a laboratory scale preparation method and B) a larger production scale preparation method.

### A. Laboratory Scale Preparation Method

All ingredients are weighed. The weighed ingredients are placed into a glass jar and blended in a tubular mixer for five minutes. The blended ingredients are then spread as thinly as possible along a flat surface to achieve a layer as close to a one particle thick as possible.

A short burst of water is then sprayed across the layer of blended ingredients with an aerosol pump. The desired amount of water may be measured before addition into the aerosol pump. (For granulated sugar, for example, water added is typically about 3.5 milliliters per 100 grams of sugar.) The blended ingredients are then mixed with a pallet knife.

To determine if enough water has been added, some of the blended ingredients are placed into a cube mold. Using the appropriate stamp, as much of the blended ingredients as possible are compacted into the mold, adding compression on both sides to increase pressure. Once the mold is full the stamp is used to push out the blended ingredients.

If the composition breaks immediately and granules disperse, there is not enough moisture. The blended ingredients are then spread, sprayed with additional water, and mixed again with the pallet knife. The blended ingredients are then re-evaluated for water content.

On the other hand, if clumps are present and part of the composition remains in the mold, too much moisture has been added to the blended ingredients. In this case, the blended ingredients must be discarded and the process restarted from the beginning.

Once an appropriate amount of water has been added, the blended ingredients are compressed in molds. The molded compositions are then placed onto a tray and dried at 70° C. in an oven. One cube is broken in half about every 10 minutes to assess breakability due to moisture content. Once the water has been removed from the cubes they should be hard throughout. The drying should take about 10 to about 30 minutes. If further drying is desired, the cubes may be placed in a 30° C. room overnight.

### B. Production Scale Preparation Method

All ingredients are weighed and blended to uniformity. The blended ingredients are then transferred to a powder hopper above a cube machine (Type C Cube Machine, Teknikeller, Ankara, Turkey). The blended ingredients are added to the mixing chamber of the cube machine and mixed with water. The amount of water is adjusted to ensure good distribution of water throughout the blended ingredients. Insufficient water will produce deposits of powder on the extraction belt used to transport cubes to the oven and result in friable cubes. Over-wetting the blended ingredients will produce visibly wet cubes, the cubes will be hard, but will have lost the sparkle associated with the glassy surface of individual crystals in conventional sucrose cubes. Target blend moisture content is about 0.5% to about 1.0%, depending on cube appearance.

The wet blended ingredients then fall by gravity from the belt into a rotating mold. Pistons compress the cubes to the required dimensions. The mass of the cubes may be adjusted by tightening the compression plate or by altering the amount of travel of the pistons. The pistons push out the formed cube onto the extraction belt, and a pushing arm pushes the cubes onto a chain conveyor to pass the cubes into the drying oven.

The shape of the mold chosen to form the cohesive non-free flowing composition determines the overall shape of the composition. Using the appropriate mold any of the shapes disclosed herein may be formed.

The cubes may then be dried in a static oven or by using a conveying (tunnel) oven. Temperatures should not exceed 70° C. for 10 to 30 minutes. The cubes may need to be “tempered” prior to packing and should cool from the drying temperature to room temperature prior to packing to avoid accumulation of condensation inside the packaging.

As discussed above the cubes may be further processed to introduce a surface feature onto the surface of the cube.

The cohesive non-free flowing sweetener compositions of the following examples may be formed using either of the two methods above.

### Example 2

Shaped cohesive non-free flowing sweetener compositions of the present invention in the shape of a rectangular prism with a length, width, and height of 12 millimeters, 12 millimeters, and 9 millimeters, respectively, are made using the laboratory scale preparation method of Example 1.A. containing the following ingredients:

1% (wt) aspartame and

99% (wt) erythritol.

Cylinders are drilled fully through the shaped cohesive non-free flowing sweetener composition centered on and perpendicular to the two parallel 12×9 millimeter surfaces of the shaped cohesive non-free flowing sweetener compositions. The diameter of the holes and the resulting masses and caloric burdens of the shaped cohesive non-free flowing sweetener composition are shown in Table 3.

TABLE 3
Masses and caloric burdens of sweetener
cubes with holes bored through

| Hole Diameter (mm) | Mass (g) | KCal/Cube |
|---|---|---|
| None | 1.40 | 0.28 |
| 3 | 1.33 | 0.26 |
| 4 | 1.28 | 0.25 |
| 5 | 1.21 | 0.24 |

In this example, taste and appearance are assessed by a panel of 3 to 4 assessors. The shaped cohesive non-free flowing sweetener composition are evaluated for appearance. The shaped cohesive non-free flowing sweetener composition are dissolved in water and the solution is evaluated for taste. Table 4 shows a comparison of the shaped cohesive non-free flowing sweetener composition produced and a sucrose cube.

TABLE 4
Comparison of the sweetener cube of the example to a
shaped cohesive non-free flowing sweetener composition.

| Characteristic | Sucrose cube | Example |
|---|---|---|
| Appearance | White, crystalline | White, crystalline |
| Taste | Sweet, syrupy | Sweet, cooling, comparable to |
| | | sucrose |
| Undesirable | None | None |
| effects | | |
| Stability | Maintains shape during storage | Maintains shape during storage and |
| | and transport | transport |
| Solubility | Approx. 30 seconds in hot water | Approx. 30 seconds in hot water |
| | (85° C.) | (85° C.) |
| Friability | Maintains integrity on handling | Maintains integrity on handling |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeter | 0–2 millimeter due to combination |
| range | | of different particulate size bulking |
| | | agents |

### Example 3

Shaped cohesive non-free flowing sweetener compositions of the present invention are made using the laboratory scale preparation method of Example 1.A. containing the following ingredients:

0.4% (wt) sucralose,

20% (wt) lactose,

75% (wt) erythritol, and

4.6% (wt) trehalose.

Molds of different shapes are employed to produce the shaped cohesive non-free flowing sweetener compositions. Table 5 shows the various shapes, dimensions, masses, and caloric burdens of the shaped cohesive non-free flowing sweetener compositions.

TABLE 5
Masses and caloric burdens of various shaped cohesive non-free
flowing sweetener compositions.

| Shape | Dimensions | Mass (g) | KCal/Cube |
|---|---|---|---|
| Rectangular | Width - 9 millimeters | 1.40 | 1.59 |
| Prism | Height - 12 millimeters | | |
| | Thickness - 12 millimeters | | |
| Waist in Two | Width - 9 millimeters | 1.15 | 1.30 |
| Dimensions | Height - 12 millimeters | | |
| | Thickness - 12 millimeters | | |
| | Waist to 5 millimeters in | | |
| | the Width and Depth | | |
| Disc | Radius - 4.5 millimeters | 1.00 | 1.13 |
| | Thickness - 12 millimeters | | |
| Star | Radius - 4.5 millimeters | 0.75 | 0.85 |
| | Thickness - 12 millimeters | | |
| Heart | Width - 9 millimeters | 0.90 | 1.02 |
| | Height - 12 millimeters | | |
| | Thickness - 12 millimeters | | |
| Moon | Radius - 4.5 millimeters | 0.75 | 0.85 |
| | Thickness - 12 millimeters | | |
| Letter “S” | Width - 9 millimeters | 1.00 | 1.13 |
| | Height - 12 millimeters | | |
| | Thickness - 12 millimeters | | |

In this example, taste and appearance are assessed by a panel of 3 to 4 assessors. The shaped cohesive non-free flowing sweetener compositions are evaluated for appearance. The shaped cohesive non-free flowing sweetener compositions are dissolved in water and the solution is evaluated for taste. Table 6 shows a comparison of the shaped cohesive non-free flowing sweetener compositions produced and a sucrose cube.

TABLE 6
Comparison of the shaped cohesive non-free flowing sweetener compositions of the
example to a sucrose cube.

| Characteristic | Sucrose cube | Example |
|---|---|---|
| Appearance | White, crystalline | White/slightly cream, crystalline |
| Taste | Sweet, syrupy | Sweet, some cooling, comparable to |
| | | sucrose |
| Undesirable | None | None |
| effects | | |
| Stability | Maintains shape during storage | Maintains shape during storage and |
| | and transport | transport |
| Solubility | Approx. 30 seconds in hot water | Approx. 40 seconds in hot water |
| | (85° C.) | (85° C.) |
| Friability | Maintains integrity on handling | Maintains integrity on handling |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeters | 0–2 millimeters due to combination |
| range | | of different particulate size bulking |
| | | agents |

### Example 4

Shaped cohesive non-free flowing sweetener compositions of the present invention in the shape of a rectangular prism with a length, width, and height of 12 millimeters, 12 millimeters, and 9 millimeters, respectively, are made using the laboratory scale preparation method of Example 1.A. containing the following ingredients:

0.4% (wt) sucralose,

10% (wt) polydextrose,

56.6% (wt) erythritol, and

33% (wt) trehalose.

The shaped cohesive non-free flowing sweetener compositions are further processed to introduce surface features, e.g., drilled or etched. Table 8 shows the various surface features and masses of the shaped cohesive non-free flowing sweetener compositions.

TABLE 8
Masses and caloric burdens of shaped cohesive non-free flowing sweetener
compositions with surface features.

| Surface Feature | Description | Mass (g) | KCal/Cube |
|---|---|---|---|
| None | Width - 9 millimeters | 1.40 | 2.15 |
| | Height - 12 millimeters | | |
| | Thickness - 12 millimeters | | |
| Cylinder Fully Through | Radius of Cylinder - 4.5 | 1.25 | 1.92 |
| | millimeters | | |
| | Perpendicular to and through the | | |
| | Sweetener Cube Surfaces of 12 | | |
| | millimeters × 12 millimeters | | |
| Cylinder Partially Through | Radius of Cylinder - 4.5 | 1.30 | 1.99 |
| | millimeters | | |
| | Perpendicular to a Sweetener | | |
| | Cube Surface of 9 millimeters × 12 | | |
| | millimeters | | |
| | Depth - 6 millimeters | | |
| Dents | Width - 9 millimeters | 1.10 | 1.69 |
| | Height - 12 millimeters | | |
| | Thickness - 12 millimeters | | |
| | Radius of Dent - 2 millimeters | | |
| | Depth of Dent - 1 millimeters | | |
| Trench | Width - 9 millimeters | 1.00 | 1.53 |
| | Height - 12 millimeters | | |
| | Thickness - 12 millimeters | | |
| | Perpendicular to 12 millimeters | | |
| | edges of the Sweetener Cube and | | |
| | Completely Circumscribing the | | |
| | Sweetener Cube | | |
| | Depth of Trench - 2 millimeters | | |
| | Width of Trench - 2 millimeters | | |
| Etching of Crosshatching | Width - 9 millimeters | 0.90 to 1.10 | 1.38 to 1.69 |
| | Height - 12 millimeters | | |
| | Thickness - 12 millimeters | | |
| | All Surfaces of the Cube | | |
| | Width of Crosshatching - | | |
| | 0.1 millimeter | | |
| | Depth of Crosshatching - | | |
| | 1 millimeters | | |

In this example, taste and appearance are assessed by a panel of 3 to 4 assessors. The cubes are evaluated for appearance. The shaped cohesive non-free flowing sweetener compositions are dissolved in water and the solution is evaluated for taste. Table 8 shows a comparison of the shaped cohesive non-free flowing sweetener compositions produced and a sucrose cube.

TABLE 8
Comparison of the shaped cohesive non-free flowing sweetener compositions of the
example to a sucrose cube.

| Characteristic | Sucrose cube | Example |
|---|---|---|
| Appearance | White, crystalline | White, crystalline |
| Taste | Sweet, syrupy | Sweet, mild cooling, comparable to |
| | | sucrose |
| Undesirable | None | None |
| effects | | |
| Stability | Maintains shape during storage | Maintains shape during storage and |
| | and transport | transport |
| Solubility | Approx. 30 seconds in hot water | Approx. 30 seconds in hot water |
| | (85° C.) | (85° C.) |
| Friability | Maintains integrity on handling | Maintains integrity on handling |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeters | 0–2 millimeters due to combination |
| range | | of different particulate size bulking |
| | | agents |

Any of the shaped cohesive non-free flowing sweetener compositions of the present invention described below may be formed into any the overall shapes disclosed above or may be modified with any of the surface features disclosed above.

### Example 5

Shaped cohesive non-free flowing sweetener compositions of the present invention having a caloric burden of 3 kilocalories are made using the laboratory scale preparation method of Example 1.A. containing the following ingredients:

0.4% (wt) sucralose,

10% (wt) polydextrose,

37.5% (wt) erythritol, and

52.1% (wt) trehalose.

In this example, taste and appearance are assessed by a panel of 3 to 4 assessors. The shaped cohesive non-free flowing sweetener compositions are evaluated for appearance. The shaped cohesive non-free flowing sweetener compositions are dissolved in water and the solution is evaluated for taste. Table 9 shows a comparison of the shaped cohesive non-free flowing sweetener compositions produced and a sucrose cube.

TABLE 9
Comparison of the shaped cohesive non-free flowing sweetener compositions of the
example to a sucrose cube.

| Characteristic | Sucrose cube | Example |
|---|---|---|
| Appearance | White, crystalline | White, crystalline |
| Taste | Sweet, syrupy | Sweet, mild cooling, comparable to |
| | | sucrose |
| Undesirable | None | None |
| effects | | |
| Stability | Maintains shape during storage | Maintains shape during storage and |
| | and transport | transport |
| Solubility | Approx. 30 seconds in hot water | Approx. 30 seconds in hot water |
| | (85° C.) | (85° C.) |
| Friability | Maintains integrity on handling | Maintains integrity on handling |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeter | 0–2 millimeter due to combination |
| range | | of different particulate size bulking |
| | | agents |

### Example 6

Shaped cohesive non-free flowing sweetener compositions of the present invention having a caloric burden of 3 kilocalories are made using the laboratory scale preparation method of Example 1.A. containing the following ingredients:

0.4% (wt) sucralose and

94.6% (wt) tagatose.

In this example, taste and appearance are assessed by a panel of 3 to 4 assessors. The shaped cohesive non-free flowing sweetener compositions are evaluated for appearance. The shaped cohesive non-free flowing sweetener compositions are dissolved in water and the solution is evaluated for taste. Table 10 shows a comparison of the shaped cohesive non-free flowing sweetener compositions produced and a sucrose cube.

TABLE 10
Comparison of the shaped cohesive non-free flowing sweetener compositions of
the example to a sucrose cube.

| Characteristic | Sucrose cube | Example |
|---|---|---|
| Appearance | White, crystalline | White/slightly cream, crystalline |
| Taste | Sweet, syrupy | Sweet, very mild cooling, slight metallic |
| | | note, comparable to sucrose |
| Undesirable | None | None |
| effects | | |
| Stability | Maintains shape during | Maintains shape during storage and |
| | storage and transport | transport. Some further development of |
| | | natural cream color. |
| Solubility | Approx. 30 seconds in hot | Approx. 30 seconds in hot water (85° C.) |
| | water (85° C.) | |
| Friability | Maintains integrity on | Maintains integrity on handling |
| | handling | |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeter | 0–2 millimeter due to combination of |
| range | | different particulate size bulking agents |

### Example 7

Shaped cohesive non-free flowing sweetener compositions of the present invention having a caloric burden of 4 kilocalories are made using the laboratory scale preparation method of Example 1.A. containing the following ingredients:

0.4% (wt) sucralose,

10% (wt) polydextrose,

29.5% (wt) erythritol, and

60.1% (wt) trehalose.

In this example, taste and appearance are assessed by a panel of 3 to 4 assessors. The shaped cohesive non-free flowing sweetener compositions are evaluated for appearance. The shaped cohesive non-free flowing sweetener compositions are dissolved in water and the solution is evaluated for taste. Table 11 shows a comparison of the shaped cohesive non-free flowing sweetener compositions produced and a sucrose cube.

TABLE 11
Comparison of the shaped cohesive non-free flowing sweetener compositions of
the example to a sucrose cube.

| Characteristic | Sucrose cube | Example |
|---|---|---|
| Appearance | White, crystalline | White, crystalline |
| Taste | Sweet, syrupy | Sweet, very mild cooling, |
| | | comparable to sucrose |
| Undesirable | None | None |
| effects | | |
| Stability | Maintains shape during storage | Maintains shape during storage and |
| | and transport | transport |
| Solubility | Approx. 30 seconds in hot water | Approx. 30 seconds in hot water (85° C.) |
| | (85° C.) | |
| Friability | Maintains integrity on handling | Maintains integrity on handling |
| Hardness | 4000 g pressure (Bench made), | Comparable to sucrose cube. 4000 g |
| | 25,000 machine made (texture | pressure (texture analyzer) |
| | analyzer) | |
| Particulate size | 0–2 millimeter | 0–2 millimeter due to combination |
| range | | of different particulate size bulking |
| | | agents |

### Example 8

Shaped cohesive non-free flowing sweetener compositions of the present invention having the ingredients in Table 12 are produced using the laboratory scale preparation method of Example 1.A.

TABLE 12
Composition and caloric burden of shaped cohesive non-free flowing sweetener
compositions of the present invention

| Formulation | Polydextrose | Tagatose | Erythritol | Trehalose | Maltodextrin | Maltose | Sucralose | KCal/ |
|---|---|---|---|---|---|---|---|---|
| Number | (% wt) | (% wt) | (% wt) | (% wt) | (% wt) | (% wt) | (% wt) | Cube |
| 1 | 9.9 | 26.6 | 10.9 | — | 7.7 | 45.0 | — | 3.67 |
| 2 | 9.9 | 26.6 | 10.9 | 45.0 | 7.7 | — | — | 3.67 |
| 3 | 5.4 | 24.3 | 25.8 | — | 13.1 | 31.5 | — | 3.15 |
| 4 | 5.4 | 24.3 | 25.8 | 31.5 | 13.1 | — | — | 3.15 |
| 5 | 8.2 | 28.9 | 36.7 | 26.3 | — | — | — | 2.29 |
| 6 | — | 36.8 | 10.8 | 15.0 | — | 37.0 | — | 3.74 |
| 7 | 9.6 | 33.0 | — | 15.0 | — | 42.0 | 0.4 | 4.04 |
| 8 | 10.0 | — | 29.5 | 15.0 | — | 45.1 | 0.4 | 3.61 |
| 9 | 10.0 | 37.5 | 28.4 | 11.2 | 2.5 | 10.0 | 0.4 | 2.36 |
| 10 | 9.9 | 26.6 | 10.9 | 35.0 | 7.7 | 10.0 | — | 3.67 |
| 11 | 9.9 | 26.6 | 10.9 | 30.0 | 7.7 | 15.0 | — | 3.67 |
| 12 | 9.9 | 26.6 | 10.9 | 25.0 | 7.7 | 20.0 | — | 3.67 |
| 13 | 9.9 | 26.6 | 10.9 | 20.0 | 7.7 | 25.0 | — | 3.67 |
| 14 | 9.9 | 26.6 | 10.9 | 15.0 | 7.7 | 30.0 | — | 3.67 |
| 15 | 9.9 | 26.6 | 10.9 | 10.0 | 7.7 | 35.0 | — | 3.67 |
| 16 | 10.0 | — | 37.5 | 40.7 | 11.8 | — | — | 3.18 |
| 17 | 10.0 | 68.0 | — | — | — | 21.5 | 0.5 | 2.80 |
| 18 | 8.2 | 28.9 | 36.7 | 15.0 | — | 10.7 | | 2.29 |
| 19 | 5.4 | 24.3 | 25.8 | 15.0 | 13.1 | 15.9 | 0.5 | 3.15 |
| 20 | — | 99.6 | — | — | — | — | 0.4 | 2.10 |
| 21 | 10.0 | — | 37.5 | 52.1 | — | — | 0.4 | 3.18 |
| 22 | — | 42.6 | — | 57.0 | — | — | 0.4 | 4.04 |
| 23 | — | 32.8 | 41.0 | 13.0 | — | 12.7 | 0.5 | 2.29 |
| 24 | — | 29.6 | 25.8 | 31.5 | 13.1 | — | — | 3.15 |
| 25 | 10.0 | 37.5 | 28.4 | 23.7 | — | — | 0.4 | 2.33 |
| 26 | 10.0 | — | 56.6 | 33.0 | — | — | 0.4 | 1.53 |

The shaped cohesive non-free flowing sweetener compositions produced above are subjected to testing for various properties.

Sucrose has a white, highly crystalline appearance. It is desirable for a shaped cohesive non-free flowing sweetener composition to have an appearance as close to a conventional sucrose cube as possible. The crystal appearance of each of the shaped cohesive non-free flowing sweetener compositions was assessed against commercially available TUTTI FREE™ (Saint Louis Sucre, Paris, France) cubes containing about 1.4 grams of sucrose. The crystal appearance of the experimental cubes was assessed on a scale of 1 to 5 by a panel of 3 to 4 people familiar with the TUTTI FREE™ product. A score of 5 represents a shaped cohesive non-free flowing sweetener composition with a crystal appearance that is virtually indistinguishable from that of the TUTTI FREE™ product and a score of 1 represents a shaped cohesive non-free flowing sweetener composition that displays virtually no crystal characteristics whatsoever.

Table 13 shows crystal appearance at 0%, 50% and 75% relative humidity for various formulations. These relative humidities represent a control (0%), the typical relative humidity found in consumers' homes (50%), and maximum expected under normal conditions (75%).

TABLE 13
Crystal appearance at 0%, 50%, and 75% relative humidity.

| | Crystal Appearance | | |
|---|---|---|---|
| Formulation | 0% Relative | 50% Relative | 75% Relative |
| Number | Humidity | Humidity | Humidity |
| 1 | 2.0 | 2.5 | 2.5 |
| 2 | 3.5 | 3.0 | 3.0 |
| 3 | 3.5 | 2.5 | 4.0 |
| 4 | 4.0 | 4.0 | 4.0 |
| 5 | 4.0 | 4.0 | 4.0 |
| 6 | 4.0 | 4.0 | 4.0 |
| 7 | 3.5 | 2.0 | 4.0 |
| 8 | 3.5 | 2.0 | 4.0 |
| 9 | 3.5 | 3.5 | 3.5 |
| 10 | 2.5 | 2.5 | 3.0 |
| 11 | 3.0 | 2.5 | 2.5 |
| 12 | 3.0 | 2.5 | 3.5 |
| 13 | 2.0 | 2.0 | 2.5 |
| 14 | 4.0 | 3.0 | 3.5 |
| 15 | 3.5 | 2.0 | 2.5 |
| 16 | 2.5 | 2.0 | 3.0 |
| 17 | 4.0 | 4.0 | 4.0 |
| 18 | 4.0 | 4.0 | 4.0 |
| 19 | 3.5 | 3.5 | 3.5 |
| 20 | 3.0 | 3.0 | 3.0 |
| 21 | 3.5 | 3.5 | 3.5 |
| 22 | 3.0 | 3.0 | 3.0 |
| 23 | 3.5 | 3.5 | 3.5 |
| 24 | 3.5 | 3.5 | 3.5 |
| 25 | 3.5 | 3.5 | 3.0 |
| 26 | 4.0 | 4.0 | 3.5 |

A crystalline appearance below about 4 will not be acceptable to a consumer as a substitute for a conventional sucrose cube.

A conventional sucrose cube has a friability of less than about 5%. To determine the friability of the experimental shaped cohesive non-free flowing sweetener compositions, each shaped cohesive non-free flowing sweetener composition is placed on a 1-millimeter mesh. The shaped cohesive non-free flowing sweetener composition is then gently brushed with a 2-inch brush to remove any loose powder. The shaped cohesive non-free flowing sweetener composition is weighed to four decimal places. The shaped cohesive non-free flowing sweetener composition is placed in the drum of a Caleva friability tester (Caleva Process Solutions Ltd, Dorset, United Kingdom) and rotated for 10 revolutions. The shaped cohesive non-free flowing sweetener composition is again placed on the mesh and gently brushed to remove any loose powder. The shaped cohesive non-free flowing sweetener composition is then re-weighed to four decimal places. The change in mass is expressed as a percent weight lost for 10 revolutions.

Table 14 shows percent friability at 0%, 50% and 75% relative humidity for various formulations with ten revolutions.

TABLE 14
Percent friability at 0%, 50%, and 75% relative humidity.

| | Friability % | | |
|---|---|---|---|
| Formulation | 0% Relative | 50% Relative | 75% Relative |
| Number | Humidity | Humidity | Humidity |
| 1 | 16.72 | 11.76 | 0.46 |
| 2 | 32.31 | 3.66 | 0.19 |
| 3 | 10.16 | 27.15 | 0.14 |
| 4 | 5.62 | 5.24 | 11.87 |
| 5 | 12.61 | 9.61 | 0.26 |
| 6 | 10.74 | 8.43 | 0.07 |
| 7 | 16.00 | 51.6 | 0.29 |
| 8 | 12.67 | 13.2 | 0.21 |
| 9 | 1.90 | 7.75 | 0.18 |
| 10 | 3.30 | 4.26 | 0.26 |
| 11 | 3.67 | 6.55 | 24.0 |
| 12 | 3.17 | 8.38 | 11.0 |
| 13 | 3.86 | 7.43 | 36.0 |
| 14 | 4.38 | 2.45 | 31.0 |
| 15 | 2.63 | 8.64 | 24.0 |
| 16 | 3.51 | 17.49 | 53.0 |
| 17 | 3.90 | 2.52 | 0.45 |
| 18 | 9.33 | 8.43 | 0.07 |
| 19 | 4.62 | 6.31 | 0.11 |
| 20 | 3.19 | 3.32 | 1.21 |
| 21 | 9.84 | 4.55 | 0.21 |
| 22 | 3.85 | 8.50 | 2.10 |
| 23 | 6.27 | 12.50 | 4.78 |
| 24 | 2.33 | 2.90 | 0.32 |
| 25 | | 1.43 | 0.15 |
| 26 | 16.72 | 0.31 | 0.17 |

If the friability of the shaped cohesive non-free flowing sweetener composition is greater than about 10% at a relative humidity of 50%, then the shaped cohesive non-free flowing sweetener compositions will crumble significantly upon transport to and use by the consumer. The consumer will not accept the loss of shape and mass by shaped cohesive non-free flowing sweetener compositions with a friability greater than about 10%.

The moisture content of each of the shaped cohesive non-free flowing sweetener compositions is determined using a moisture meter (MX-50 or MD-50, A&D Engineering, Inc., Milpitas, Calif.). The moisture meter measures the percent weight lost by the shaped cohesive non-free flowing sweetener composition upon complete drying based on the total weight of the shaped cohesive non-free flowing sweetener composition Table 15 shows moisture content at 0%, 50% and 75% relative humidity for various formulations.

TABLE 15
Moisture content at 0%, 50%, and 75% relative humidity.

| | Moisture Content (%(wt)) | | |
|---|---|---|---|
| Formulation | 0% Relative | 50% Relative | 75% Relative |
| Number | Humidity | Humidity | Humidity |
| 1 | 2.98 | 3.02 | 3.10 |
| 2 | 3.84 | 3.88 | 0.66 |
| 3 | 2.06 | 4.34 | 1.76 |
| 4 | 2.41 | 3.43 | 1.60 |
| 5 | 1.53 | 2.28 | 4.03 |
| 6 | 2.90 | 3.69 | 3.76 |
| 7 | 5.07 | 5.30 | 4.90 |
| 8 | 3.86 | 6.35 | 4.02 |
| 9 | 1.90 | 2.05 | 1.71 |
| 10 | 3.30 | 3.94 | 3.01 |
| 11 | 3.67 | 3.92 | 2.01 |
| 12 | 3.17 | 3.36 | 2.01 |
| 13 | 3.86 | 4.36 | 2.60 |
| 14 | 4.38 | 3.11 | 1.77 |
| 15 | 2.63 | 3.75 | 1.95 |
| 16 | 3.51 | 3.75 | 2.10 |
| 17 | 1.83 | 2.61 | 2.17 |
| 18 | 2.23 | 2.71 | 2.68 |
| 19 | 2.30 | 3.67 | 2.13 |
| 20 | 1.44 | 1.39 | 1.70 |
| 21 | 3.46 | 7.19 | 5.11 |
| 22 | 1.89 | 4.77 | 5.26 |
| 23 | 3.49 | 3.50 | 2.94 |
| 24 | 4.46 | 2.24 | 4.98 |
| 25 | 2.53 | 3.63 | 2.10 |
| 26 | 2.20 | 4.01 | 4.54 |

If the moisture content of the cube is greater than about 3%, then the shaped cohesive non-free flowing sweetener compositions may become soft and friable, and may also adhere to each other. The consumer will not accept shaped cohesive non-free flowing sweetener composition with a moisture content greater than about 5% because they will be soft to handle, lack crunch on consumption, and will not be comparable to sucrose cubes that are familiar to consumers.

A conventional sucrose cube has a hardness of about 30,000 g and a rigidity of about 30,000 g/s. The hardness and rigidity for each of the experimental shaped cohesive non-free flowing sweetener compositions is determined using a TA-XT2i Texture Analyzer (Stable Micro Systems Ltd., Surrey, England). The shaped cohesive non-free flowing sweetener composition to be tested is placed horizontally on the testing platform of the analyzer, directly under a 1-inch diameter probe. The probe size ensures that compression occurs on flat edges to get an actual hardness value for the shaped cohesive non-free flowing sweetener composition. The analyzer settings are as follows:

| | | |
|---|---|---|
| Test Speed: | 1 | mm/s |
| Rupture Test Distance: | 4 | mm |
| Distance: | 1 | mm |
| Force: | 100 | g |
| Time: | 5 | sec |
| Load Cell: | 50 | Kg |

Table 16 shows hardness at 0%, 50% and 75% relative humidity for various formulations.

TABLE 16
Hardness at 0%, 50%, and 75% relative humidity.

| | Hardness (g) | | |
|---|---|---|---|
| Formulation | 0% Relative | 50% Relative | 75% Relative |
| Number | Humidity | Humidity | Humidity |
| 1 | 1824 | 1255 | 99 |
| 2 | 1179 | 496 | 1476 |
| 3 | 1615 | 438 | 1360 |
| 4 | 953 | 684 | 1142 |
| 5 | 1270 | 2783 | 2888 |
| 6 | 1981 | 1500 | 6300 |
| 7 | 2318 | 2949 | 5715 |
| 8 | 2927 | 1916 | 4304 |
| 9 | 779 | 2067 | 84 |
| 10 | 589 | 4228 | 627 |
| 11 | 2460 | 2833 | 538 |
| 12 | 188 | 690 | 176 |
| 13 | 2666 | 2097 | 509 |
| 14 | 934 | 2756 | 234 |
| 15 | 2228 | 1131 | 1054 |
| 16 | 776 | 872 | 2200 |
| 17 | 1606 | 1656 | 319 |
| 18 | 661 | 770 | 28 |
| 19 | 1651 | 1322 | 145 |
| 20 | 3465 | 690 | 426 |
| 21 | 4036 | 782 | 240 |
| 22 | 4295 | 1211 | 210 |
| 23 | 2752 | 649 | 1248 |
| 24 | 840 | 2482 | 129 |
| 25 | 3566 | 3092 | 83 |
| 26 | 2376 | 2725 | 1135 |

If the hardness of the shaped cohesive non-free flowing sweetener composition is less than about 5000 g, then the shaped cohesive non-free flowing sweetener composition will become friable and can be broken by manual pressure. The consumer will not accept shaped cohesive non-free flowing sweetener compositions with a hardness greater than about 30000 g as these will dissolve too slowly in a beverage such as tea or coffee, i.e., much more slowly than a conventional sucrose cube.

Table 17 shows rigidity at 0%, 50% and 75% relative humidity for various formulations.

TABLE 17
Rigidity at 0%, 50%, and 75% relative humidity.

| | Rigidity (g/s) | | |
|---|---|---|---|
| Formulation | 0% Relative | 50% Relative | 75% Relative |
| Number | Humidity | Humidity | Humidity |
| 1 | 1797 | 1980 | 46 |
| 2 | 1265 | 1266 | 1466 |
| 3 | 1577 | 1578 | 1341 |
| 4 | 953 | 954 | 1106 |
| 5 | 1245 | 1246 | 2845 |
| 6 | 1977 | 1978 | 6252 |
| 7 | 2301 | 2302 | 5620 |
| 8 | 3077 | 3078 | 4263 |
| 9 | 8 | 2032 | 78 |
| 10 | 623 | 4167 | 613 |
| 11 | 2432 | 2804 | 533 |
| 12 | 176 | 670 | 167 |
| 13 | 3392 | 2074 | 494 |
| 14 | 911 | 2717 | 222 |
| 15 | 2548 | 1103 | 1037 |
| 16 | 766 | 842 | 2179 |
| 17 | 2762 | 2828 | 544 |
| 18 | 656 | 781 | 16 |
| 19 | 1610 | 1304 | 136 |
| 20 | 3400 | 667 | 496 |
| 21 | 3974 | 762 | 233 |
| 22 | 4983 | 1262 | 197 |
| 23 | 2754 | 619 | 1704 |
| 24 | 828 | 2558 | 118 |
| 25 | 3566 | 3053 | 74 |
| 26 | 2337 | 2682 | 1135 |

If the rigidity of the shaped cohesive non-free flowing sweetener composition is greater than about 10,000 g/s, then the shaped cohesive non-free flowing sweetener compositions will become difficult to dissolve in liquid or crumble for use on foods. The consumer will not accept this slow dissolution of shaped cohesive non-free flowing sweetener compositions with a rigidity greater than about 30,000 g/s.

Three to five panelists familiar with the TUTTI FREE™ (or reference cube) product determined the stickiness of each of the shaped cohesive non-free flowing sweetener compositions. The panelists arrived at a value for the stickiness of the experimental shaped cohesive non-free flowing sweetener compositions using the 0-5 scale of Table 18 by group discussion. On this scale, the TUTTI FREE™ product has a stickiness of 5.

TABLE 18
Stickiness assessment scale.

| | Stickiness | | | | | |
|---|---|---|---|---|---|---|
| Scale | 5 | 4 | 3 | 2 | 1 | 0 |
| Criteria | Cube; as | Cube; | Cube; tacky to | Cube; sticks | Cube; | Liquified. |
| | control. | slightly soft. | the touch. | to finger | adhesive | |
| | | | | when lifted. | and forms a | |
| | | | | | strand when | |
| | | | | | removed. | |

Table 19 shows stickiness at 0%, 50% and 75% relative humidity for various formulations.

TABLE 19
Stickiness at 0%, 50%, and 75% relative humidity.

| | Stickiness | | |
|---|---|---|---|
| Formulation | 0% Relative | 50% Relative | 75% Relative |
| Number | Humidity | Humidity | Humidity |
| 1 | 5 | 5 | 5 |
| 2 | 5 | 5 | 5 |
| 3 | 5 | 5 | 5 |
| 4 | 5 | 5 | 5 |
| 5 | 5 | 5 | 5 |
| 6 | 5 | 5 | 4 |
| 7 | 5 | 5 | 4 |
| 8 | 5 | 5 | 4 |
| 9 | 5 | 4.5 | 4 |
| 10 | 5 | 5 | 5 |
| 11 | 5 | 5 | 3 |
| 12 | 5 | 5 | 5 |
| 13 | 5 | 5 | 5 |
| 14 | 5 | 5 | 5 |
| 15 | 5 | 5 | 5 |
| 16 | 5 | 5 | 5 |
| 18 | 5 | 4 | 2 |
| 19 | 5 | 5 | 2 |
| 20 | 5 | 5 | 5 |
| 21 | 5 | 4 | |
| 22 | 5 | 5 | 5 |
| 23 | 5 | 5 | 5 |
| 24 | 5 | 5 | 2.5 |
| 25 | 5 | 05 | 3 |
| 26 | 5 | 5 | 4 |

Shaped cohesive non-free flowing sweetener compositions that have a stickiness less than about 3.5 at 50% relative humidity will adhere to one other and to any surface that they contact. Such shaped cohesive non-free flowing sweetener compositions will not be convenient for or useable by the consumer.

A conventional sucrose cube has a dissolution time in water of about 5 to 20 seconds depending on cube size and water temperature. To determine the dissolution time of each of the experimental shaped cohesive non-free flowing sweetener compositions a 2-liter flask is filled with about 1 liter of water and placed on a magnetic stirring plate with heating plate. A 400-millimeter stirbar is placed in the flask. The water is heated to the desired temperature and stirred at about 150 to 180 rpm. A sieve with 1- or 1.18-millimeter mesh is placed mesh up, submerged in the water inside the flask above the stirring plate. The mesh is marked with an indelible marker for precise location of the cube. Using tweezers, the shaped cohesive non-free flowing sweetener composition to be tested is placed on the sieve using the indelible mark for precise placement. The time from submersion of the shaped cohesive non-free flowing sweetener composition and to complete dissolution is measured. The time of dissolution is recorded for 5 sweetener cubes of the same composition. The dissolution time is the average of the five individual dissolution times.

Table 20 shows dissolution time at 21° C., 55° C., and 85° C. for various formulations. These temperatures represent the temperatures of hot beverages (85° C. or 55° C.) and room temperature (21° C.).

TABLE 20
Dissolution time at 21° C., 55° C., and 85° C.

| Formulation | Dissolution Time (s) | | |
|---|---|---|---|
| Number | 85° C. | 55° C. | 21° C. |
| 1 | 45 | 13 | 195 |
| 2 | 43 | 12 | 290 |
| 3 | 117 | 18 | 300 |
| 4 | 97 | 44 | 230 |
| 5 | 16 | 28 | 40 |
| 6 | 44 | 27 | 300 |
| 7 | 32 | 31 | 215 |
| 8 | 20 | 43 | 127 |
| 9 | 15 | 14 | 98 |
| 10 | 6 | 31 | 23 |
| 11 | 32 | 42 | 153 |
| 12 | 19 | 16 | 108 |
| 13 | 37 | 23 | 127 |
| 14 | 8 | 42 | 42 |
| 15 | 38 | 39 | 78 |
| 16 | 10 | 18 | 300 |
| 17 | 45 | 47 | 147 |
| 18 | 14 | 35 | 84 |
| 19 | 20 | 98 | 73 |
| 20 | 8 | 24 | 68 |
| 21 | 27 | 27 | 97 |
| 22 | 23 | 24 | 154 |
| 23 | 53 | 25 | 300 |
| 24 | 46 | 257 | 285 |
| 25 | 25 | 21 | 56 |
| 26 | 19 | 65 | 320 |

Shaped cohesive non-free flowing sweetener compositions that have a dissolution time greater than about 60 seconds in a hot beverage (85° C.) will not dissolve quickly enough to satisfy a consumer.

### Example 9

Additional examples of shaped cohesive non-free flowing sweetener compositions of the present invention having a mass of 1.4 grams have the ingredients shown in Table 21:

TABLE 21
Sweetener cube formulations.

| Ingredient (%(wt)) | | | | | | | | |
|---|---|---|---|---|---|---|---|---|
| Polydextrose | Tagatose | Erythritol | Trehalose | Maltodextrin | Maltose | Lactose | Sucralose | KCal/Cube |
| | 99.6 | | | | | | 0.4 | 2.09 |
| 10.0 | 37.5 | 28.4 | 11.2 | 2.5 | 10.0 | | 0.4 | 2.33 |
| | 32.8 | 41 | 13 | | 12.7 | | 0.5 | 2.24 |
| 10.0 | 37.5 | 28.4 | 23.7 | | | | 0.4 | 2.33 |
| 10.0 | 68.0 | | | | 21.5 | | 0.5 | 2.77 |
| 5.4 | 24.3 | 25.8 | 15.0 | 13.1 | 15.9 | | 0.5 | 3.12 |
| 10.0 | | 37.5 | 52.1 | | | | 0.4 | 3.16 |
| 9.6 | 33.0 | | 15.0 | | 42.0 | | 0.4 | 4.02 |
| 10.0 | | 29.5 | 15.0 | | 45.1 | | 0.4 | 3.59 |
| | 42.6 | | 57.0 | | | | 0.4 | 4.09 |
| 20.0 | 7.0 | | | | | 72.5 | 0.5 | 4.49 |
| 5.0 | 25.0 | | | | | 69.5 | 0.5 | 4.49 |
| | 3.0 | | | | | 96.5 | 0.5 | 5.47 |
| 20.0 | 37.0 | | | 20.0 | | 22.5 | 0.5 | 3.44 |
| 20.0 | | 22.0 | | | | 55.5 | 0.5 | 3.45 |
| | | 40.0 | | | | 59.5 | 0.5 | 3.44 |

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated reference in their entirety. In case of conflict, the present specification, including definitions, will control.

What is claimed is:

1. A cohesive non-free flowing sweetener composition comprising a high intensity sweetener and a bulking agent, wherein the cohesive non-free flowing sweetener composition has a decreased volume and an equivalent sweetness compared to that of a conventional sucrose cube of the same dimensions.

2. A cohesive non-free flowing sweetener composition according to claim 1, wherein the cohesive non-free flowing sweetener composition has a shape selected from the group consisting of waists in two dimensions, pyramids, cylinders, spheres, cones, discs, and fun shapes.

3. A cohesive non-free flowing sweetener composition according to claim 1, wherein the surface of the sweetener cube has been modified with a surface feature to provide a lower volume compared to a conventional sucrose cube of about the same dimensions without modifying the overall shape of the cube.

4. A cohesive non-free flowing sweetener composition according to claim 4, wherein the surface feature is selected from the group consisting of dimples, dents, divots, trenches, holes fully or partially through the cohesive non-free flowing sweetener composition, and etchings.

5. A cohesive non-free flowing sweetener composition according to claim 1, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hemandulcin, monellin, mogroside, neotame, neohesperidin, saccharin, sucralose, stevia, thaumatin, their respective salts and combinations thereof.

6. A cohesive non-free flowing sweetener composition according to claim 6, wherein the high intensity sweetener is sucralose.

7. A cohesive non-free flowing sweetener composition according to claim 1, wherein the bulking agent is selected from the group consisting of glucose, allose, altrose, mannose, idose, galactose, talose, ribose, arabinose, xylose, lyxose, cellobiose, gentiobiose, isomaltose, lactose, laminarabinose, maltose, amylose, mannobiose, xylobiose, trehalose, cellobiose, lactulose, fructose, tagatose, lactitol, aerated sugars, aerated polyols, aerated complex carbohydrates, cyclodextrins, raffinose, cellulose, inulin, gum arabic, nutriose, maltodextrin, fibrisol, raftiline, raftilose, isomalt, lactitol, maltitol, xylitol, erythritol, mannitol, sorbitol, soluble fiber, protein, calcium citrate, calcium lactate and combinations thereof.

8. A cohesive non-free flowing sweetener composition comprising about 0.4% sucralose and about 99.6% erythritol by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and:
a) wherein at least one cylinder of a diameter from about 1.5 to about 5 millimeters is bored through and perpendicular to two parallel surfaces of the cohesive non-free flowing sweetener composition, or
b) wherein one or two of the surfaces have been modified with at least one dent.

9. A cohesive non-free flowing sweetener composition comprising about 0.4% sucralose, about 75% erythritol, about 20% crystalline lactose, and about 4.6% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 9 millimeters by about 9 millimeters by about 9 millimeters and six surfaces and:
a) wherein at least one cylinder of a diameter from about 1.5 to about 5 millimeters is bored through and perpendicular to two parallel surfaces of the cohesive non-free flowing sweetener composition, or
b) wherein one or two of the surfaces have been modified with at least one dent.

10. A cohesive non-free flowing sweetener composition comprising about 0.4% sucralose, about 10% polydextrose, about 57% erythritol, and from about 26% to about 33% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and:
a) wherein at least one cylinder of a diameter from about 1.5 to about 5 millimeters is bored through and perpendicular to two parallel surfaces of the cohesive non-free flowing sweetener composition or
b) wherein one or two of the surfaces have been modified with at least one dent.

11. A cohesive non-free flowing sweetener composition comprising about 0.4% sucralose, about 10% polydextrose, about 38% erythritol, and from about 45% to about 52% trehalose by weight based on the total weight of the sweetener cube, wherein the sweetener cube has a sweetness equal to one teaspoon of sucrose and is in the shape of a rectangular prism having dimensions of about 12 millimeters by about 12 millimeters by about 9 millimeters and six surfaces and:
a) wherein at least one cylinder of a diameter from about 1.5 to about 5 millimeters is bored through and perpendicular to two parallel surfaces of the cohesive non-free flowing sweetener composition, or
b) wherein one or two of the surfaces have been modified with at least one dent.

12. A cohesive non-free flowing sweetener composition comprising about 0.4% sucralose, about 10% polydextrose, about 30% erythritol, and about 60% trehalose by weight based on the total weight of the cohesive non-free flowing sweetener composition, wherein the cohesive non-free flowing sweetener composition has a sweetness equal to one teaspoon of sucrose and is in the shape of a rectangular prism having dimensions of about 12 millimeters by about 12 millimeters by about 9 millimeters and six surfaces and:
a) wherein at least one cylinder of a diameter from about 1.5 to about 5 millimeters is bored through and perpendicular to two parallel surfaces of the sweetener cube of cohesive non-free flowing sweetener composition, or
b) wherein one or two of the surfaces have been modified with at least one dent.

13. A method for making a low-calorie cohesive non-free flowing sweetener composition comprising:
(a) combining a high intensity sweetener with a bulking agent to form a blend;
(b) adding water to the blend;
(c) forming the blend from (b) into a shape; and
(d) drying the shape,
wherein either the shape has a volume lower than that of a conventional sucrose cube of the same dimensions or the cohesive non-free flowing sweetener composition is modified with a surface feature.

15. A method according to claim 14, wherein the surface feature is selected from the group consisting of dimples, dents, divots, trenches, holes fully or partially through the cube, and etchings.

16. A low-calorie sweetener cube made by the process of claim 14.
